(19) United States
(12) Patent Application Publication
(10) Pub. No.: US 2025/0378610 A1
(43) Pub. Date: Dec. 11, 2025

(54) INFORMATION PROCESSING METHOD, RECORDING MEDIUM, AND INFORMATION PROCESSING TERMINAL

(71) Applicant: Panasonic Holdings Corporation, Osaka (JP)

(72) Inventors: Motoshi Anabuki, Hyogo (JP); Shunsuke Kuhara, Osaka (JP)

(21) Appl. No.: 19/313,078

(22) Filed: Aug. 28, 2025

Related U.S. Application Data
(63) Continuation of application No. PCT/JP2024/003091, filed on Jan. 31, 2024.
(60) Provisional application No. 63/452,518, filed on Mar. 16, 2023.

(51) Int. Cl. G06T 11/60

(52) U.S. Cl. CPC G06T 11/60

(57) ABSTRACT

An information processing method is to be executed by a computer, and includes: obtaining mobile body information items respectively related to mobile bodies; causing a display device to display the mobile body information items obtained; and retaining, when the display of the mobile body information items on the display device is changed, a relative positional relationship of one or more mobile body information items displayed on the display device both before and after the change.

### CROSS REFERENCE TO RELATED APPLICATIONS

This is a continuation application of PCT International Application No. PCT/JP2024/003091 filed on Jan. 31, 2024, designating the United States of America, which is based on and claims priority of U.S. Provisional Patent Application No. 63/452,518 filed on Mar. 16, 2023. The entire disclosures of the above-identified applications, including the specifications, drawings and claims are incorporated herein by reference in their entirety.

### FIELD

The present disclosure relates to an information processing method, a recording medium, and an information processing terminal for outputting information related to mobile bodies that move autonomously.

### BACKGROUND

Patent Literature (PTL) 1 discloses a multi-split screen display system that displays a plurality of videos. In a multi-split screen newly generated for displaying an arbitrary video in an enlarged manner, this system increases the display area of the video to be displayed in an enlarged manner, and decreases the display area of the other videos.

### CITATION LIST

### Patent Literature

PTL 1: Japanese Unexamined Patent Application Publication No. 2008-28876

### SUMMARY

### Technical Problem

However, in the technique disclosed in PTL 1, for example, in a case where an operator is remotely monitoring a plurality of mobile body information items respectively related to a plurality of mobile bodies by simultaneously displaying, on a display device, the plurality of mobile body information items, when the display of each mobile body information item on the display device is changed, the position of each mobile body information item on the display device may be changed. In such a case, there is a problem that the operator has to identify again which mobile body information item is at which position, and the burden on the operator tends to increase.

Therefore, the present disclosure provides an information processing method and the like with which the positional relationship of each mobile body information item is unlikely to be changed on a display device on which a plurality of mobile body information items respectively related to a plurality of mobile bodies are displayed.

### Solution to Problem

An information processing method according to one aspect of the present disclosure is to be executed by a computer, and the includes: obtaining mobile body information items respectively related to mobile bodies causing a display device to display the mobile body information items obtained; and retaining, when the display of the mobile body information items on the display device is changed, a relative positional relationship of one or more mobile body information items displayed on the display device both before and after the change.

It should be noted that these general or specific aspects of the present disclosure may be realized by a system, a device, a method, an integrated circuit, a computer program, a computer-readable non-transitory recording medium such as a CD-ROM, or any combination thereof.

### Advantageous Effects

According to an information processing method and the like according to one aspect of the present disclosure, the positional relationship of each mobile body information item is unlikely to be changed on the display device on which the plurality of mobile body information items respectively related to the plurality of mobile bodies are displayed.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating one example of an overall configuration including an information processing terminal according to an embodiment.

FIG. 2 is a flowchart illustrating a basic operation example of the information processing terminal according to the embodiment.

FIG. 3 is a flowchart illustrating a display retaining process in the basic operation example of the information processing terminal according to the embodiment.

FIG. 4 is an explanatory diagram in a case of deleting a mobile body information item in the basic operation example of the information processing terminal according to the embodiment.

FIG. 5 is an explanatory diagram in a case of adding a mobile body information item in the basic operation example of the information processing terminal according to the embodiment.

FIG. 6 is an explanatory diagram of the operation of an information processing terminal according to a comparative example.

FIG. 7 is an explanatory diagram of the basic operation example of the information processing terminal according to the embodiment.

FIG. 8 is a flowchart illustrating a case where the total number of separations of display areas is decreased in a first operation example of the information processing terminal according to the embodiment.

FIG. 9 is an explanatory diagram of a specific operation in the case where the total number of separations of the display areas is decreased in the first operation example of the information processing terminal according to the embodiment.

FIG. 10 is a flowchart illustrating a case where the total number of separations of the display areas is increased in the first operation example of the information processing terminal according to the embodiment.

FIG. 11 is an explanatory diagram of a specific operation in the case where the total number of separations of the display areas is increased in the first operation example of the information processing terminal according to the embodiment.

FIG. 12 is a flowchart illustrating a second operation example of the information processing terminal according to the embodiment.

FIG. 13 is an explanatory diagram of a specific operation in the second operation example of the information processing terminal according to the embodiment.

FIG. 14 is a flowchart illustrating a third operation example of the information processing terminal according to the embodiment.

FIG. 15 is a flowchart illustrating an example of determination of a specific mobile body information item in the third operation example of the information processing terminal according to the embodiment.

FIG. 16 is a diagram illustrating one example of state information.

FIG. 17 is an explanatory diagram of a specific operation in the third operation example of the information processing terminal according to the embodiment.

FIG. 18 is a flowchart illustrating a fourth operation example of the information processing terminal according to the embodiment.

FIG. 19 is an explanatory diagram of a specific operation in the fourth operation example of the information processing terminal according to the embodiment.

### DESCRIPTION OF EMBODIMENT

An information processing method according to a first aspect of the present disclosure is to be executed by a computer, and includes: obtaining mobile body information items respectively related to mobile bodies causing a display device to display the mobile body information items obtained; and retaining, when the display of the mobile body information items on the display device is changed, a relative positional relationship of one or more mobile body information items displayed on the display device both before and after the change.

Accordingly, since the relative positional relationship of one or more mobile body information items displayed on the display device is retained both before and after the change of the plurality of mobile body information items on the display device, there is an advantage that the positional relationship of each mobile body information item on the display device is unlikely to be changed. In addition, accordingly, there is an advantage that an operator does not need to identify again which mobile body information item is displayed at which position, and the burden on the operator is easily reduced.

For example, in an information processing method according to a second aspect of the present disclosure, in the first aspect of the present disclosure, the mobile body information items are separately displayed in display areas of the display device, and when the total number of the display areas is changed, the relative positional relationship of the one or more mobile body information items displayed on the display device both before and after the change is retained.

Accordingly, even in a case where the total number of the plurality of display areas on the display device is changed, since the relative positional relationship of one or more mobile body information items displayed on the display device is retained both before and after the change, there is an advantage that the positional relationship of each mobile body information item on the display device is unlikely to be changed.

For example, in an information processing method according to a third aspect of the present disclosure, in the second aspect of the present disclosure, when a change in the total number of the display areas changes the position of a mobile body information item among the mobile body information items on the display device, the display device is caused to display the change in the position of the mobile body information item by animation.

Accordingly, there is an advantage that the operator can easily identify how the mobile body information item whose position is changed has changed.

For example, in an information processing method according to a fourth aspect of the present disclosure, in any one of the first to the third aspects of the present disclosure, when a change in the display of the mobile body information items on the display device changes the position of a mobile body information item among the mobile body information items on the display device, the display device is caused to display the mobile body information item more emphasized than the remainder of the mobile body information items.

Accordingly, there is an advantage that the operator can easily identify which mobile body information item changes its position.

For example, in an information processing method according to a fifth aspect of the present disclosure, in any one of the first to the fourth aspects of the present disclosure, when the display of the mobile body information items on the display device is changed, the position of a mobile body information item related to a specific mobile body among one or more mobile body information items displayed on the display device both before and after the change is retained.

Accordingly, since the position of, for example, the mobile body information item of a mobile body that is intensively monitored by the operator is not changed before and after the change of the display of the plurality of mobile body information items on the display device, there is an advantage that the operator is unlikely to lose track of the mobile body information item of the mobile body intensively monitored by the operator.

For example, in an information processing method according to a sixth aspect of the present disclosure, in the fifth aspect of the present disclosure, the specific mobile body is determined based on state information items indicating states of the mobile bodies.

Accordingly, since the operator need not manually determine the specific mobile body, there is an advantage that the burden on the operator is likely to be reduced.

For example, a program according to a seventh aspect of the present disclosure causes a computer to execute the information processing method according to any one of the first to the sixth aspects of the present disclosure.

Accordingly, even in a case where the total number of the plurality of display areas on the display device is changed, since the relative positional relationship of one or more mobile body information items displayed on the display device is retained both before and after the change, there is an advantage that the positional relationship of each mobile body information item on the display device is unlikely to be changed. In addition, accordingly, there is an advantage that the operator does not need to identify again which mobile body information item is displayed at which position, and the burden on the operator is easily reduced.

For example, an information processing terminal according to an eighth aspect of the present disclosure includes an obtainer and a processor. The obtainer obtains mobile body information items respectively related to mobile bodies. The processor causes a display device to display the mobile body information items obtained by the obtainer. When the display of the mobile body information items on the display device is changed, the processor retains the relative positional relationship of one or more mobile body information items displayed on the display device both before and after the change.

Accordingly, even in a case where the total number of the plurality of display areas on the display device is changed, since the relative positional relationship of one or more mobile body information items displayed on the display device is retained both before and after the change, there is an advantage that the positional relationship of each mobile body information item on the display device is unlikely to be changed. In addition, accordingly, there is an advantage that the operator does not need to identify again which mobile body information item is displayed at which position, and the burden on the operator is easily reduced.

Hereinafter, embodiments will be specifically described with reference to the drawings.

It should be noted that each of the exemplary embodiments described below shows a general or specific example of the present disclosure. The numerical values, shapes, materials, elements, the arrangement and connection of the elements, steps, an order of steps etc. shown in the following exemplary embodiments are mere examples, and therefore do not intend to limit the essence of the present disclosure.

### Embodiment

Hereinafter, an information processing terminal and an information processing method according to an embodiment will be described.

### 1. Configuration

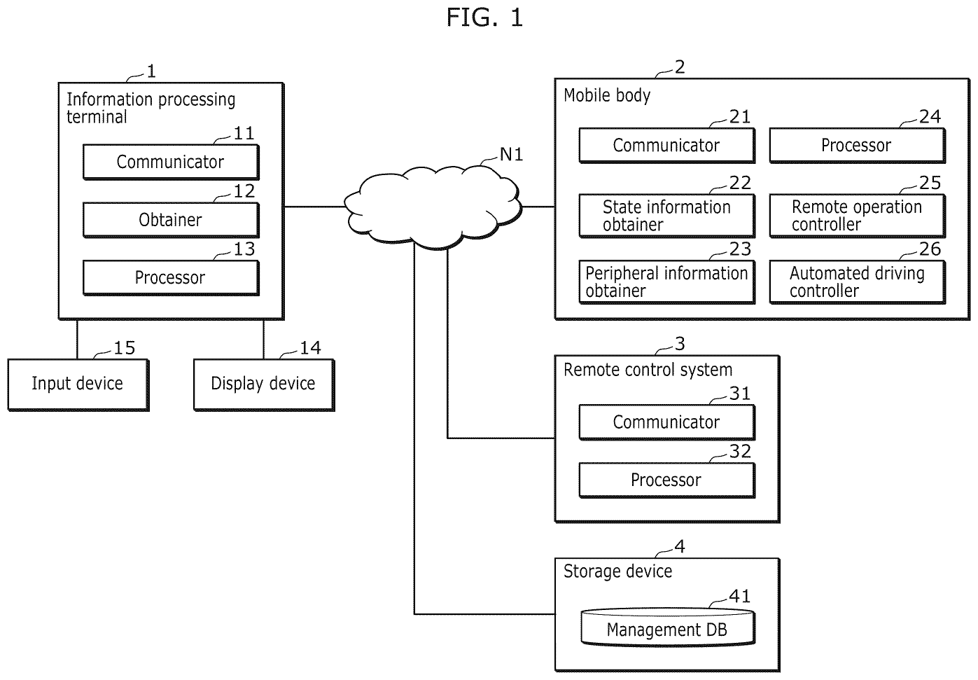

FIG. 1 is a block diagram illustrating one example of an overall configuration including information processing terminal 1 according to an embodiment. Information processing terminal 1 is, for example, a smartphone, a tablet terminal, a personal computer, or the like, and is a terminal for outputting the information related to mobile body 2 that moves autonomously. In the embodiment, information processing terminal 1 is a terminal used by an operator for remotely monitoring a plurality of mobile bodies 2 via remote control system 3, which will be described later. In addition, hereinafter, information processing terminal 1 will be described as a personal computer. In FIG. 1, although one information processing terminal 1 is illustrated, for example, when a plurality of operators are present, a plurality of information processing terminals 1 to be respectively used by the plurality of operators are present.

Mobile body 2 includes, for example, an autonomous mobile robot, such as an automatic delivery robot. Mobile body 2 may be autonomously mobile, and can include, for example, a vehicle such as an automobile or a motorcycle, other than robots. In addition, in the embodiment, mobile body 2 is not completely autonomously mobile, and is remotely monitored by the operator via remote control system 3. Furthermore, in some cases, mobile body 2 can be moved by remote control by the operator via remote control system 3. Hereinafter, mobile body 2 will be described as an automatic delivery robot, particularly, an automatic delivery robot that moves on a sidewalk instead of a roadway. Of course, mobile body 2 may be an automatic delivery robot that moves on a roadway.

As illustrated in FIG. 1, mobile body 2 includes communicator 21, state information obtainer 22, peripheral information obtainer 23, processor 24, remote operation controller 25, and automated driving controller 26. Communicator 21, state information obtainer 22, peripheral information obtainer 23, processor 24, remote operation controller 25, and automated driving controller 26 are realized by a processor that executes programs stored in memories, a communication interface, and the like. The memories are a ROM (Read Only Memory), RAM (Random Access Memory), and the like, and can store the programs to be executed by the processor.

Communicator 21 is a wireless communication interface for communicating with remote control system 3 via, for example, network N1 such as the Internet. Communicator 21 transmits, to remote control system 3, the state information related to the state of mobile body 2 obtained by state information obtainer 22, and the peripheral information related to the periphery of mobile body 2. In addition, communicator 21 receives an indication signal that indicates an instruction for remote control of mobile body 2 transmitted from, for example, remote control system 3.

State information obtainer 22 obtains the state information related to the state of mobile body 2. The state information may include, for example, the information indicating the position of mobile body 2, the information indicating the remaining power of a battery mounted on mobile body 2, the information indicating the communication status between mobile body 2 and remote control system 3, the information indicating the movement state of mobile body 2, or the like. The movement state may include, for example, the information indicating whether or not mobile body 2 is moving autonomously, the information indicating whether or not mobile body 2 is remotely operated by the operator, the information indicating whether or not mobile body 2 is standing by, or the like. In addition, the state information may include, for example, the information indicating whether or not a failure has occurred in mobile body 2, the information indicating whether or not mobile body 2 is stuck, or the like.

State information obtainer 22 obtains the state information by, for example, requesting the state of mobile body 2 from processor 24. In addition, state information obtainer 22 obtains, as the state information, the position of mobile body 2 detected based on a positioning result of a positioning system such as a GPS (Global Positioning System).

Peripheral information obtainer 23 obtains the peripheral information related to the periphery of mobile body 2 from an image captured with a camera mounted on mobile body 2, or a detection result of a sensor that detects the peripheral environment, such as LIDAR (Light Detection And Ranging), mounted on mobile body 2. The peripheral information may include, for example, the information indicating whether or not an object is present in the periphery of mobile body 2.

Processor 24 is a main controller of mobile body 2. Processor 24 cooperates with each of communicator 21, state information obtainer 22, peripheral information obtainer 23, remote operation controller 25, and automated driving controller 26 to execute management and control of entire mobile body 2.

Remote operation controller 25 controls mobile body 2 according to the content instructed to mobile body 2 from remote control system 3 via network N1, so as to cause mobile body 2 to move autonomously. Accordingly, mobile body 2 is remotely operated according to the instruction by the operator.

Automated driving controller 26 controls mobile body 2 according to the content instructed to mobile body 2 from remote control system 3 via network N1, so as to cause mobile body 2 to move autonomously. The instruction here is different from the aforementioned instruction by the operator. For example, when mobile body 2 is an automatic delivery robot, automated driving controller 26 causes mobile body 2 to move autonomously according to instructions for moving toward one or more delivery destinations.

Remote control system 3 is a system that is operated in a remote control center or a server device at which a plurality of operators are present, and that is for each operator to remotely monitor, or in some cases to execute a remote operation of, a plurality of mobile bodies 2. Each operator uses information processing terminal 1 to monitor the status of each mobile body 2 displayed on a display attached to information processing terminal 1. In addition, for example, when there is a demand of remote operation from mobile body 2, or when each operator determines that mobile body 2 is in a state where mobile body 2 is to be remotely operated, each operator remotely operates mobile body 2. In the embodiment, remote control system 3 will be described as being realized by a server device.

As illustrated in FIG. 1, remote control system 3 includes communicator 31 and processor 32. Communicator 31 and processor 32 are realized by a processor that executes programs stored in the memories, a communication interface, and the like. The memories are a ROM, a RAM, and the like, and can store the programs executed by the processor. In addition, remote control system 3 communicates with storage device 4 via network N1 to read and refer to the information stored in storage device 4. It should be noted that storage device 4 may be mounted on the same server device as the server device of remote control system 3.

Communicator 31 is a wireless communication interface for communicating with each of the plurality of mobile bodies 2 targeted by remote control system 3 via network N1. Communicator 31 receives, for each mobile body 2, the state information and the peripheral information that are transmitted from mobile body 2. In addition, communicator 31 communicates with information processing terminal 1 used by the operator via network N1. It should be noted that when a plurality of information processing terminals 1 are present, communicator 31 communicates with each of the plurality of information processing terminals 1.

Processor 32 is a main controller of remote control system 3. Processor 32 cooperates with communicator 31 to execute management and control of entire remote control system 3. For example, when communicator 31 receives the state information and the peripheral information that are transmitted from each mobile body 2 via network N1, processor 32 stores, for each mobile body 2, the received state information and the peripheral information in management DB (Database) 41 of storage device 4, which will be described later. In addition, for example, based on a request from information processing terminal 1, processor 32 transmits, to requesting information processing terminal 1 via communicator 31 and network N1, the state information and the peripheral information of one or more mobile bodies 2 that are specified among the plurality of mobile bodies 2. It should be noted that when a plurality of information processing terminals 1 are present, processor 32 executes the above-described process for each of the plurality of information processing terminals 1.

Storage device 4 stores management DB 41. Management DB 41 stores, for each mobile body 2, the state information and the peripheral information that are transmitted from mobile body 2. The state information and the peripheral information stored in management DB 41 for each mobile body 2 are updated each time processor 32 obtains the state information and the peripheral information of each mobile body 2 via communicator 31.

As illustrated in FIG. 1, information processing terminal 1 includes communicator 11, obtainer 12, and processor 13. In addition, display device 14 and input device 15 are connected to information processing terminal 1. It should be noted that information processing terminal 1 may include display device 14 and input device 15.

Communicator 11 is a communication interface for communicating with remote control systems 3 via network N1. Communicator 11 may be a wired communication interface, or may be a wireless communication interface.

Obtainer 12 obtains a plurality of mobile body information items respectively related to the plurality of mobile bodies 2 from remote control system 3 via communicator 11 and network N1. Here, each of the plurality of mobile body information items includes at least one of the state information and the peripheral information of corresponding mobile body 2. In the embodiment, obtainer 12 obtains, from remote control system 3, the plurality of mobile body information items respectively related to the plurality of mobile bodies 2 specified by an input to input device 15 by the operator.

Processor 13 is a main controller of information processing terminal 1. Processor 13 cooperates with each of communicator 11, obtainer 12, display device 14, and input device 15 to execute management and control of entire information processing terminal 1.

Processor 13 executes a display process of displaying, on display device 14, the plurality of mobile body information items obtained by obtainer 12. In the display process, processor 13 controls at which position on display device 14 each of the plurality of mobile body information items is to be displayed. For example, processor 13 displays each of the plurality of mobile body information items on display device 14, such that the plurality of mobile body information items are aligned in the order of the mobile body ID that is the identifier assigned to each of the plurality of mobile bodies 2, or in the order of the name of each of the plurality of mobile bodies 2.

In addition, processor 13 executes a display change process of changing the display of the plurality of mobile body information items on display device 14, according to an input to input device 15 by the operator. The display change process is executed when, for example, the operator gives an input to add and display, on display device 14, the mobile body information item related to new mobile body 2 to input device 15. In addition, the display change process is executed when, for example, the operator gives an input to stop the display of the mobile body information item of any of the plurality of mobile body information items to input device 15.

Furthermore, when processor 13 executes the display change process, that is, when processor 13 changes the display of the plurality of mobile body information items on display device 14, processor 13 executes a display retaining process of retaining the relative positional relationship of one or more mobile body information items displayed on display device 14 both before and after the change. The specific aspect of the display retaining process by processor 13 will be described in detail in “2. Operation”.

Display device 14 is, for example, a liquid crystal display or the like, and displays information processed by processor 13. The specific aspect of the information displayed on display device 14 will be described in detail in “2. Operation”.

Input device 15 is an interface that receives an input by the operator. In the embodiment, input device 15 includes, for example, pointing devices such as a keyboard and a mouse. It should be noted that when display device 14 constitutes a touch panel display, display device 14 also serve as input device 15.

### 2. Operation

Hereinafter, the operation of information processing terminal 1 according to the embodiment will be described.

### 2-1. Basic Operation Example

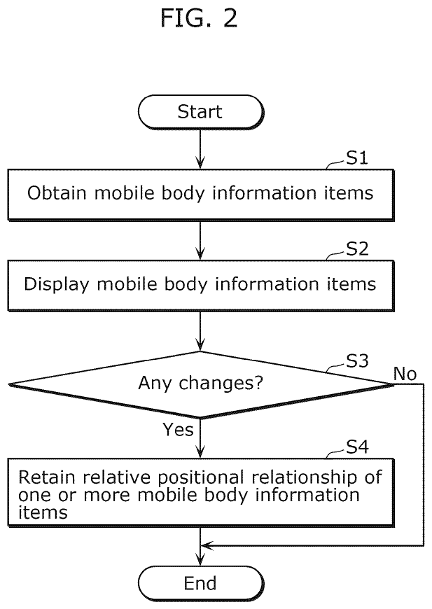

First, a basic operation example of information processing terminal 1 will be described with reference to FIG. 2. FIG. 2 is a flowchart illustrating the basic operation example of information processing terminal 1 according to the embodiment.

First, obtainer 12 obtains, from remote control system 3, a plurality of mobile body information items respectively related to a plurality of mobile bodies 2 specified by an input to input device 15 by an operator (S1). For example, when the operator gives an input to specify a total of four mobile bodies 2 with mobile body IDs of “01”, “02”, “03”, and “04”, obtainer 12 requests the mobile body information items of these four mobile bodies 2 from remote control system 3 via communicator 11 and network N1. Accordingly, obtainer 12 obtains the mobile body information items of these four mobile bodies 2 transmitted from remote control system 3 via communicator 11 and network N1.

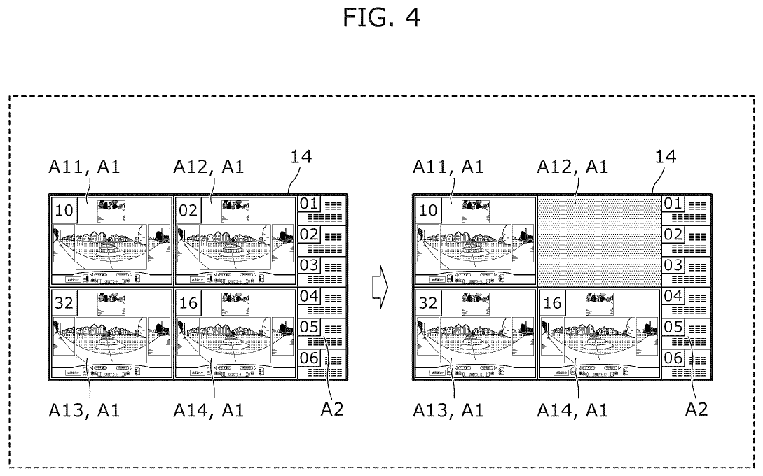

Next, processor 13 executes the display process of displaying, on display device 14, the plurality of mobile body information items obtained by obtainer 12 (S2). For example, when the plurality of mobile body information items obtained by obtainer 12 are the mobile body information items of a total of four mobile bodies 2 described above, processor 13 separates a screen of display device 14 into four display areas A1 (refer to FIG. 4 and the like), and displays the mobile body information items of the four mobile bodies 2 in the four display areas A1, respectively.

Thereafter, when changing the display of the plurality of mobile body information items on display device 14 (S3: Yes), processor 13 executes the display retaining process of retaining the relative positional relationship of one or more mobile body information items displayed on display device 14 both before and after the change (S4). For example, it is assumed that the mobile body information items of four mobile bodies 2 with the mobile body IDs of “01”, “02”, “03”, and “04” are displayed on display device 14, and the mobile body information item of mobile body 2 with the mobile body ID of “03” is to be deleted. In this case, processor 13 retains the relative positional relationship of the mobile body information items of three mobile bodies 2 with the mobile body IDs of “01”, “02”, and “04”. On the other hand, when the display of the plurality of mobile body information items on display device 14 is not changed (S3: No), processor 13 maintains the current display of the plurality of mobile body information items on display device 14.

Here, retaining the relative positional relationship of one or more mobile body information items means that the positions of the other mobile body information items do not change before and after the change, when seen from the position of an arbitrary mobile body information item on display device 14. For example, when there is a positional relationship that the mobile body information item with the mobile body ID of “02” is located below the mobile body information item with the mobile body ID of “01” on display device 14 before the change, this positional relationship is also retained on display device 14 after the change.

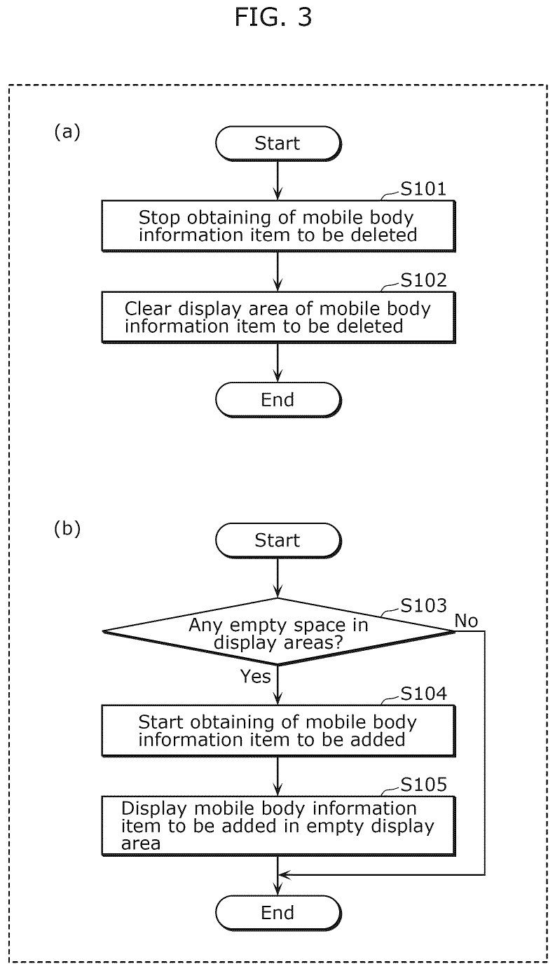

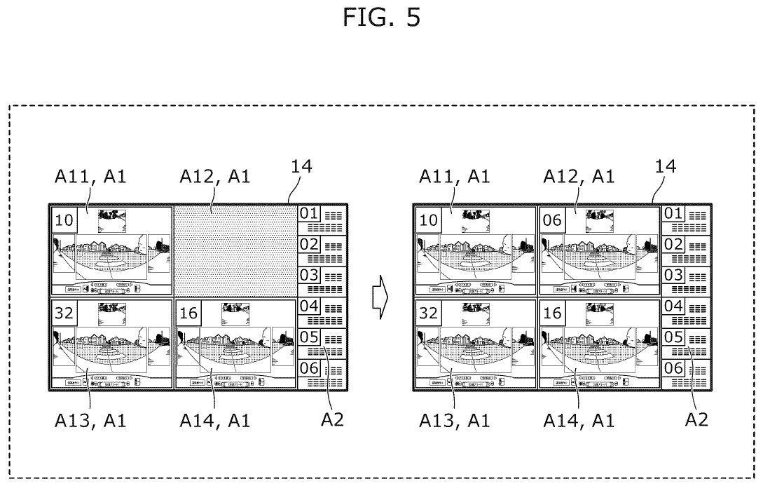

Next, the display retaining process in the basic operation example of information processing terminal 1 will be described with reference to FIG. 3 to FIG. 5. FIG. 3 is a flowchart illustrating the display retaining process in the basic operation example of information processing terminal 1 according to the embodiment. FIG. 4 is an explanatory diagram in a case of deleting a mobile body information item in the basic operation example of information processing terminal 1 according to the embodiment. FIG. 5 is an explanatory diagram in a case of adding a mobile body information item in the basic operation example of information processing terminal 1 according to the embodiment. In addition, (a) in FIG. 3 illustrates a flowchart in a case of deleting a mobile body information item, and (b) in FIG. 3 illustrates a flowchart in a case of adding a mobile body information item.

First, a description will be given of the case of deleting any one mobile body information item from a plurality of mobile body information items displayed on display device 14, with reference to (a) in FIG. 3 and FIG. 4. As illustrated in (a) in FIG. 3, when an input to stop monitoring of any of mobile bodies 2 is given by the input to input device 15 by the operator, processor 13 stops obtaining of the mobile body information item of this mobile body 2, that is, the mobile body information item to be deleted (S101). Subsequently, obtainer 12 does not request the mobile body information item to be deleted, from remote control system 3. Then, processor 13 clears display area A1 of the mobile body information item to be deleted on display device 14 (S102). Subsequently, display area A1 in which the mobile body information item to be deleted has been displayed on display device 14 turns into empty display area A1 in which no mobile body information item is displayed.

A specific example of the above-described process will be described with reference to FIG. 4. In the example illustrated in FIG. 4, four display areas A1 (first display area A11, second display area A12, third display area A13, and fourth display area A14) and list A2 of a plurality of mobile bodies 2 that can be remotely monitored are displayed on display device 14. The mobile body information item of mobile body 2 with a mobile body ID of “10” is displayed in first display area A11, and the mobile body information item of mobile body 2 with the mobile body ID of “02” is displayed in second display area A12. The mobile body information item of mobile body 2 with a mobile body ID of “32” is displayed in third display area A13, and the mobile body information item of mobile body 2 with a mobile body ID of “16” is displayed in fourth display area A14.

The state information and the peripheral information are displayed in each display area A1 as the mobile body information. Here, the information indicating whether or not mobile body 2 is remotely operated by the operator, such as “remote operation in progress”, the information indicating whether or not mobile body 2 is moving autonomously, and the like are displayed in each display area A1 as the state information. In addition, moving route R1 of mobile body 2 is displayed in each display area A1 as the state information. In addition, front image P11, rear image P12, left image P13, and right image P14 captured with cameras mounted on mobile body 2 are displayed in each display area A1 as the peripheral information.

List A2 displays a list of all mobile bodies 2 that are managed by remote control system 3, and that can be remotely monitored by the operator. It should be noted that when the list of all mobile bodies 2 does not fit on display device 14, the operator can give an input to scroll a scroll bar of list A2 in an up-down direction, so as to display the list of desired mobile bodies 2 on display device 14.

In the example illustrated in FIG. 4, a mobile body information item to be deleted is the mobile body information item of mobile body 2 with the mobile body ID of “02”. Therefore, second display area A12 in which the mobile body information item to be deleted is displayed is cleared, and second display area A12 turns into empty display area A1. In addition, in the example illustrated in FIG. 4, there is no change in the position on display device 14 of each of the mobile body information items of mobile bodies 2 with the mobile body IDs of “10”, “32”, and “16” displayed on display device 14 both before and after the deletion of the mobile body information item (that is, before and after the change). That is, the relative positional relationship of these mobile body information items is retained.

Next, a description will be given of the case of adding a mobile body information item to be displayed on display device 14, with reference to (b) in FIG. 3 and FIG. 5. As illustrated in (b) in FIG. 3, when an input to start monitoring of any of mobile bodies 2 is given by the input to input device 15 by the operator, processor 13 checks whether or not there is an empty space in display areas A1 on display device 14 (S103). When there is an empty space in display areas A1 on display device 14, that is, when empty display area A1 is present (S103: Yes), processor 13 starts obtaining of the mobile body information item of mobile body 2 specified by the operator, that is, the mobile body information item to be added (S104). Subsequently, obtainer 12 requests the mobile body information item to be added, from remote control system 3. Then, processor 13 displays the mobile body information item to be added in empty display area A1 on display device 14 (S105). On the other hand, when there is no empty space in display area A1 on display device 14 (S103: No), processor 13 maintains the current display of the plurality of mobile body information items on display device 14.

A specific example of the above-described process will be described with reference to FIG. 5. In the example illustrated in FIG. 5, the mobile body information item of mobile body 2 with the mobile body ID of “10” is displayed in first display area A11, the mobile body information item of mobile body 2 with the mobile body ID of “32” is displayed in third display area A13, and the mobile body information item of mobile body 2 with the mobile body ID of “16” is displayed in fourth display area A14. In addition, second display area A12 is empty display area A1.

In the example illustrated in FIG. 5, the mobile body information item to be added is the mobile body information item of mobile body 2 with a mobile body ID of “06”. Therefore, the mobile body information item to be added is displayed in second display area A12, which is empty display area A1. In addition, in the example illustrated in FIG. 5, there is no change in the position on display device 14 of each of the mobile body information items of mobile bodies 2 with the mobile body IDs of “10”, “32”, and “16” displayed on display device 14 both before and after the addition of the mobile body information item (that is, before and after the change). That is, the relative positional relationship of these mobile body information items is retained.

### 2-2. Advantages

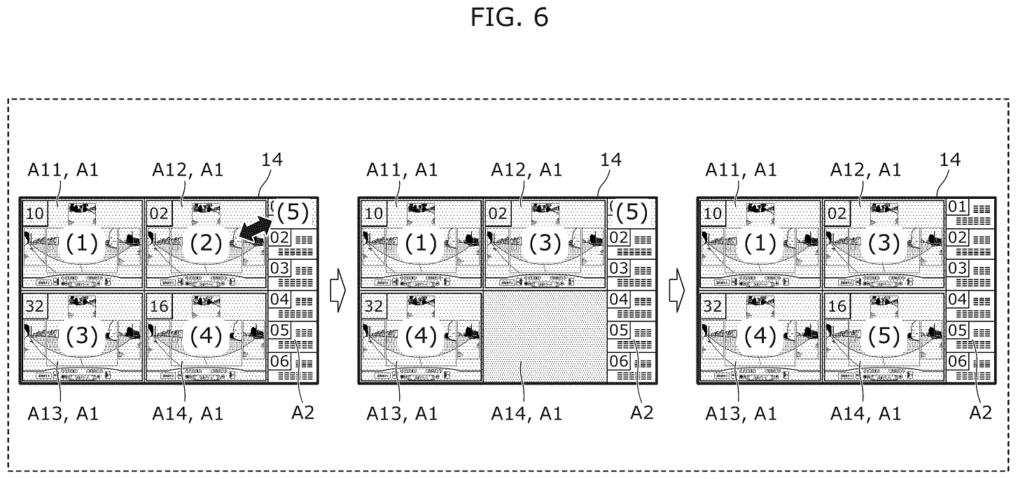

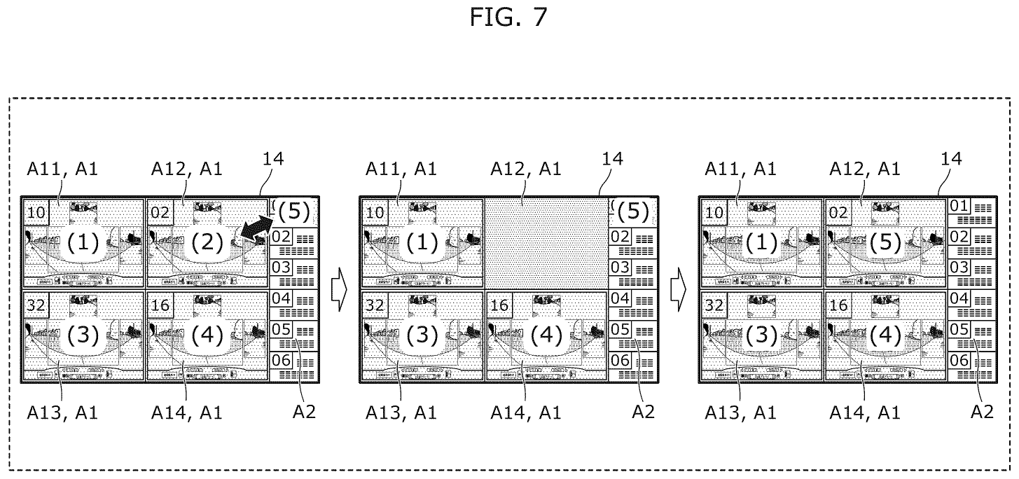

Hereinafter, the advantages of information processing terminal 1 and the information processing method according to the embodiment will be described with a comparison with an information processing terminal according to a comparative example. FIG. 6 is an explanatory diagram of the operation of the information processing terminal according to the comparative example. FIG. 7 is an explanatory diagram of the basic operation example of information processing terminal 1 according to the embodiment. Hereinafter, it is assumed that, as illustrated in FIG. 6 and FIG. 7, in display device 14, mobile body information item (1) is displayed in first display area A11, mobile body information item (2) is displayed in second display area A12, mobile body information item (3) is displayed in third display area A13, and mobile body information item (4) is displayed in fourth display area A14. In addition, hereinafter, it is assumed that, as illustrated in FIG. 6 and FIG. 7, a mobile body information item to be deleted is mobile body information item (2), and a mobile body information item to be added is mobile body information item (5).

As illustrated in FIG. 6, in the information processing terminal according to the comparative example, when second display area A12 in which mobile body information item (2), which is the mobile body information item to be deleted, is displayed is cleared, mobile body information item (3) moves to second display area A12, and mobile body information item (4) moves to third display area A13, so as to fill second display area A12. In addition, mobile body information item (5), which is the mobile body information item to be added, is displayed in fourth display area A14 that has become empty display area A1.

In this manner, in the information processing terminal according to the comparative example, the positions of mobile body information items (3) and (4) of mobile body information items (1), (3), and (4) displayed on display device 14 both before and after the deletion and addition of the mobile body information items (that is, before and after the change) are changed, and the relative positional relationship of these mobile body information items is disrupted. Therefore, there is a problem that the operator has to identify again which mobile body information item is displayed at which position, and the burden on the operator tends to increase.

On the other hand, as illustrated in FIG. 7, in information processing terminal 1 according to the embodiment, even when second display area A12 in which mobile body information item (2), which is the mobile body information item to be deleted, is displayed is cleared, the other mobile body information items (1), (3), and (4) are not moved. Then, mobile body information item (5), which is the mobile body information item to be added, is displayed in second display area A12 that has become empty display area A1.

In this manner, in information processing terminal 1 according to the embodiment, the positions of mobile body information items (1), (3), and (4) displayed on display device 14 both before and after the deletion and addition of the mobile body information items (that is, before and after the change) are not changed, and the relative positional relationship of these mobile body information items is retained. Therefore, in information processing terminal 1 according to the embodiment, there is an advantage that the positional relationship of each mobile body information item on display device 14 is unlikely to be changed. In addition, this advantage provides an advantage that the operator does not need to identify again which mobile body information item is displayed at which position, and the burden on the operator is easily reduced.

### 2-3. First Operation Example

Hereinafter, a first operation example that can be executed by information processing terminal 1 will be described. It should be noted that information processing terminal 1 may execute the basic operation example, and whether or not to execute the first operation example is optional. In the first operation example, processor 13 executes the display retaining process, when the total number of separations of the plurality of display areas A1 displayed on display device 14 is increased or decreased. That is, in the first operation example, the plurality of mobile body information items are separately displayed in the plurality of display areas A1 on display device 14. In addition, in the first operation example, when changing the total number of the plurality of display areas A1, processor 13 retains the relative positional relationship of one or more mobile body information items displayed on display device 14 both before and after the change.

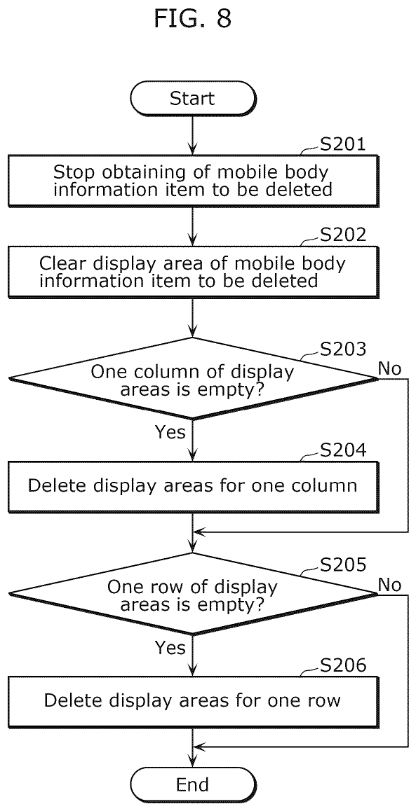

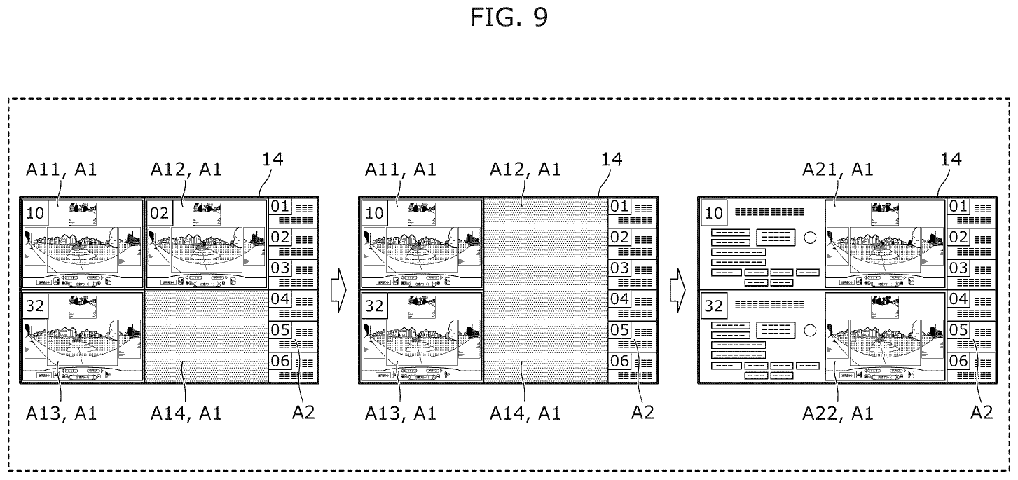

First, a description will be given of a case where the total number of separations of the plurality of display areas A1 displayed on display device 14 decreases is described, with reference to FIG. 8 and FIG. 9. FIG. 8 is a flowchart illustrating the case where the total number of separations of display areas A is decreased in the first operation example of information processing terminal 1 according to the embodiment. FIG. 9 is an explanatory diagram of a specific operation in the case where the total number of separations of display areas A is decreased in the first operation example of information processing terminal 1 according to the embodiment.

As illustrated in FIG. 8, when an input to stop monitoring of any of mobile bodies 2 is given by the input to input device 15 by the operator, processor 13 stops obtaining of the mobile body information item of this mobile body 2, that is, the mobile body information item to be deleted (S201). Subsequently, obtainer 12 does not request the mobile body information item to be deleted, from remote control system 3. Then, processor 13 clears display area A1 of the mobile body information item to be deleted on display device 14 (S202). Subsequently, display area A1 in which the mobile body information item to be deleted has been displayed on display device 14 turns into empty display area A1 in which no mobile body information item is displayed.

Here, when one column of display areas A1 on display device 14 is empty after the deletion of the mobile body information item (S203: Yes), processor 13 deletes display areas A1 for the one column on display device 14 (S204). Accordingly, the total number of separations of display areas A1 on display device 14 is decreased. On the other hand, when one column of display areas A1 is not empty on display device 14 after the deletion of the mobile body information item (S203: No), and one row of display areas A1 is empty (S205: Yes), processor 13 deletes display areas A1 for the one row on display device 14 (S206). Accordingly, the total number of separations of display areas A1 on display device 14 is decreased. It should be noted that when neither one column nor one row of display areas A1 is empty on display device 14 after the deletion of the mobile body information item (S205: No), processor 13 maintains the total number of separations of display areas A1.

A specific example of the above-described process will be described with reference to FIG. 9. In the example illustrated in FIG. 9, the mobile body information item of mobile body 2 with the mobile body ID of “10” is displayed in first display area A11, the mobile body information item of mobile body 2 with the mobile body ID of “02” is displayed in second display area A12, and the mobile body information item of mobile body 2 with the mobile body ID of “32” is displayed in third display area A13. In addition, fourth display area A14 is empty display area A1.

In the example illustrated in FIG. 9, a mobile body information item to be deleted is the mobile body information item of mobile body 2 with the mobile body ID of “02”. Therefore, since second display area A12 is cleared, and the column in which second display area A12 and fourth display area A14 are arranged becomes empty, processor 13 deletes this column. Consequently, the total number of separations of display areas A1 becomes “2”, and first display area A21 and second display area A22 are displayed on display device 14.

Here, the mobile body information item of mobile body 2 with the mobile body ID of “10” is displayed in first display area A21, and the mobile body information item of mobile body 2 with the mobile body ID of “32” is displayed in second display area A22. Therefore, there is no change in the relative position on display device 14 of each of the mobile body information items of mobile bodies 2 with the mobile body IDs of “10” and “32” displayed on display device 14 both before and after the decrease in the total number of separations of display areas A1. Specifically, there is no change in the positional relationship that the mobile body information item of mobile body 2 with the mobile body ID of “32” is located below the mobile body information item of mobile body 2 with the mobile body ID of “10”. That is, the relative positional relationship of these mobile body information items is retained.

It should be noted that, as in the example illustrated in FIG. 9, when the total number of separations of display areas A1 is decreased, information more detailed than that in display area A1 (here, first display area A11 and the like) before the decrease in the total number of separations is displayed in display area A1 (here, first display area A21 and the like) after the decrease in the total number of separations. In the example illustrated in FIG. 9, compared with display area A1 before the decrease in the total number of separations, detailed state information is displayed in display area A1 after the decrease in the total number of separations.

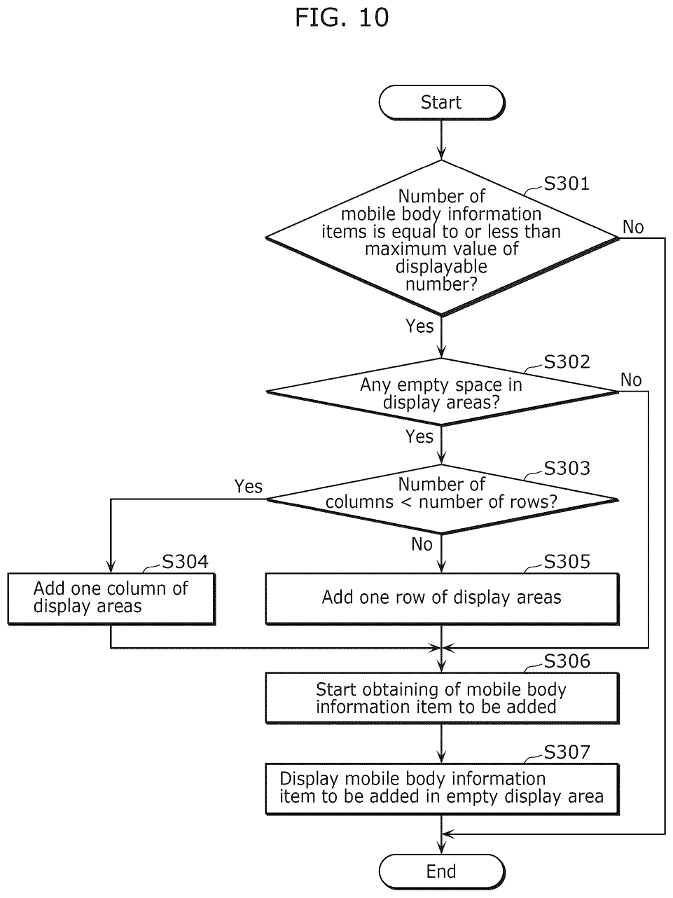

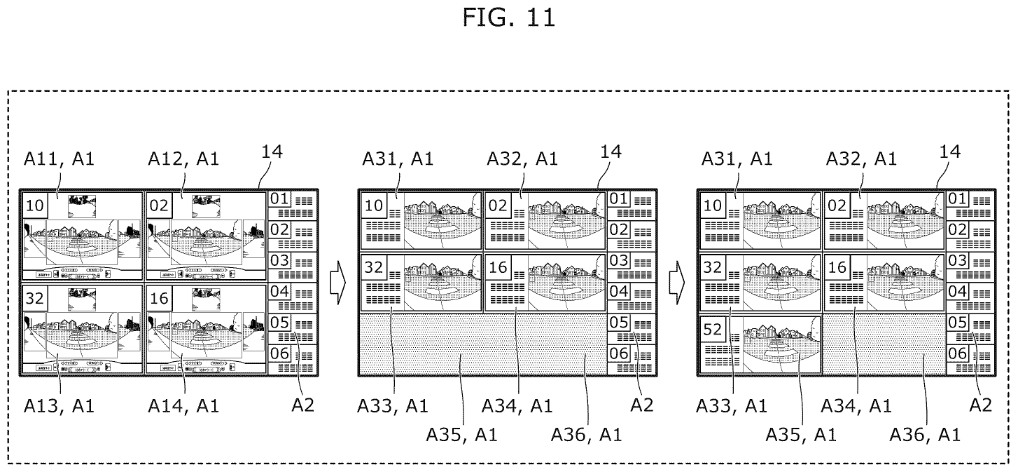

Next, a description will be given of a case where the total number of separations of the plurality of display areas A1 displayed on display device 14 is increased will be described, with reference to FIG. 10 and FIG. 11. FIG. 10 is a flowchart illustrating the case where the total number of separations of display areas A1 is increased in the first operation example of information processing terminal 1 according to the embodiment. FIG. 11 is an explanatory diagram of a specific operation in the case where the total number of separations of display areas A1 is increased in the first operation example of information processing terminal 1 according to the embodiment.

As illustrated in FIG. 10, when an input to start monitoring of any of mobile bodies 2 is given by the input to input device 15 by the operator, processor 13 checks whether or not the total number of mobile body information items is equal to or less than the maximum value of the displayable number of display devices 14 (S301). When the total number of mobile body information items is equal to or less than the maximum value of the displayable number of display devices 14 (S301: Yes), processor 13 checks whether or not there is an empty space in display areas A1 on display device 14 (S302).

When there is an empty space in display areas A1 on display device 14 (S302: Yes), and when the total number of columns of display areas A1 is less than the total number of rows of display areas A1 (S303: Yes), processor 13 adds one column of display areas A1 on display device 14 (S304). Accordingly, the total number of separations of display areas A1 on display device 14 is increased. On the other hand, when the total number of columns of display areas A1 is greater than the total number of rows of display areas A1 (S303: No), processor 13 adds one row of display areas A1 on display device 14 (S305). Accordingly, the total number of separations of display areas A1 on display device 14 is increased. It should be noted that when the total number of columns and the total number of rows on display device 14 are the same, processor 13 may add one column of display areas A1 on display device 14, or may add one row of display areas A1 on display device 14.

Thereafter, processor 13 starts obtaining of the mobile body information item of mobile body 2 specified by the operator, that is, the mobile body information item to be added (S306). Subsequently, obtainer 12 requests the mobile body information item to be added, from remote control system 3. Then, processor 13 displays the mobile body information item to be added in empty display area A1 on display device 14 (S307).

It should be noted that when there is no empty space in display areas A1 on display device 14 (S302: No), processor 13 executes steps S306 and S307 without executing steps S303 to S305. In addition, when the total number of mobile body information items exceeds the maximum value of the displayable number of display device 14 (S301: No), processor 13 maintains the current display of the plurality of mobile body information items on display device 14.

A specific example of the above-described process will be described with reference to FIG. 11. In the example illustrated in FIG. 11, the mobile body information item of mobile body 2 with the mobile body ID of “10” is displayed in first display area A1, and the mobile body information item of mobile body 2 with the mobile body ID of “02” is displayed in second display area A12. In addition, the mobile body information item of mobile body 2 with the mobile body ID of “32” is displayed in third display area A13, and the mobile body information item of mobile body 2 with the mobile body ID of “16” is displayed in fourth display area A14.

In the example illustrated in FIG. 11, since there is no empty space in display areas A1, and the total number of rows and the total number of columns of display areas A1 on display device 14 are the same, here, processor 13 adds a row of display areas A1 on display device 14. Accordingly, the total number of separations of display areas A1 on display device 14 is increased from “4” to “6”, and six display areas A1 (first display area A31, second display area A32, third display area A33, fourth display area A34, fifth display area A35, and sixth display area A36) are displayed on display device 14.

In the example illustrated in FIG. 11, the mobile body information item to be added is the mobile body information item of mobile body 2 with a mobile body ID of “52”. Therefore, the mobile body information item to be added is displayed in empty display area A1 (here, fifth display area A35).

Here, the mobile body information item of mobile body 2 with the mobile body ID of “10” is displayed in first display area A31, and the mobile body information item of mobile body 2 with the mobile body ID of “02” is displayed in second display area A32. In addition, the mobile body information item of mobile body 2 with the mobile body ID of “32” is displayed in third display area A33, and the mobile body information item of mobile body 2 with the mobile body ID of “16” is displayed in fourth display area A34. Therefore, there is no change in the relative position on display device 14 of each of the mobile body information items of mobile bodies 2 with the mobile body IDs of “10”, “02”, “32”, and “16” displayed on display device 14 both before and after the increase in the total number of separations of display areas A1. Specifically, there is no change in the positional relationship that the mobile body information items of mobile bodies 2 with the mobile body IDs of “02”, “32”, and “16” are respectively located to the right of, below, and diagonally below and to the right of the mobile body information item of mobile body 2 with the mobile body ID of “10”. That is, the relative positional relationship of these mobile body information items is retained.

It should be noted that, as in the example illustrated in FIG. 11, when the total number of separations of display areas A1 is increased, information simpler than that in display area A1 (here, first display area A11 and the like) before the increase in the total number of separations is displayed in display area A1 (here, first display area A31 and the like) after the increase in the total number of separations. In the example illustrated in FIG. 11, compared with display area A1 before the increase in the total number of separations, simple peripheral information is displayed in display area A1 after the increase in the total number of separations.

### 2-4. Second Operation Example

Hereinafter, a second operation example that can be executed by information processing terminal 1 will be described. It should be noted that information processing terminal 1 may execute the basic operation example, and whether or not to execute the second operation example is optional. In the second operation example, when the total number of separations of a plurality of display areas A1 displayed on display device 14 is increased or decreased, processor 13 executes the display retaining process, while displaying the movement of a mobile body information item whose position is changed by animation. That is, in the second operation example, when a change in the number of display areas A1 changes the position of a mobile body information item among the mobile body information items on display device 14, processor 13 causes display device 14 to display the change in the position of the mobile body information item by animation.

In addition, in the second operation example, processor 13 displays the mobile body information item whose position is changed in an emphasized manner. That is, in the second operation example, when a change in the display of the plurality of mobile body information items on display device 14 changes the position of a mobile body information item among the mobile body information items on display device 14, processor 13 causes display device 14 to display the mobile body information item more emphasized than the remainder of the mobile body information items.

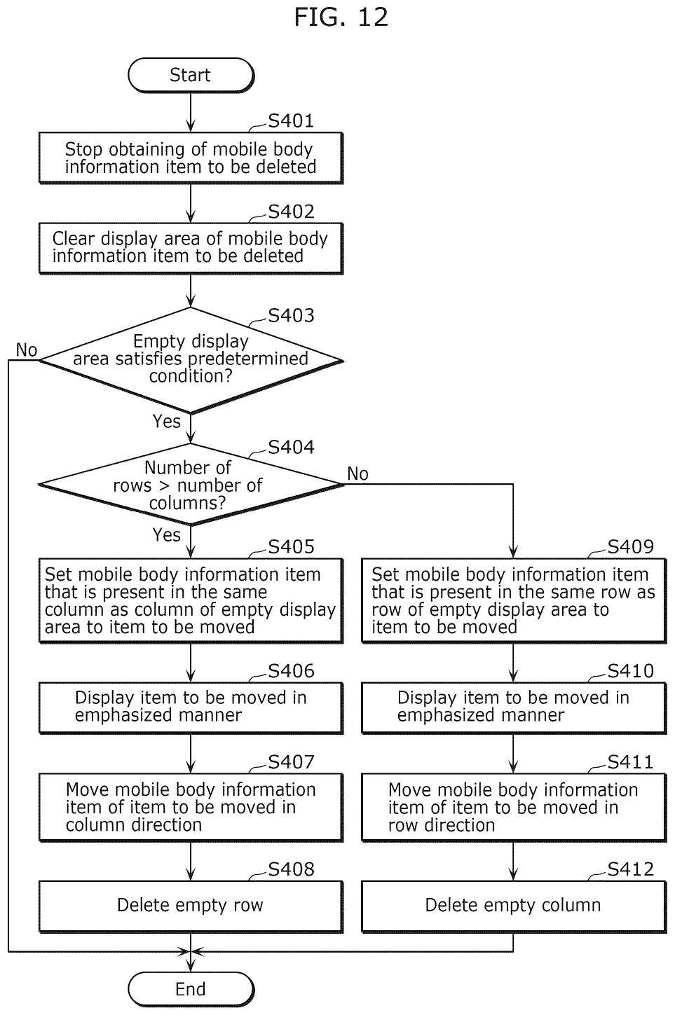

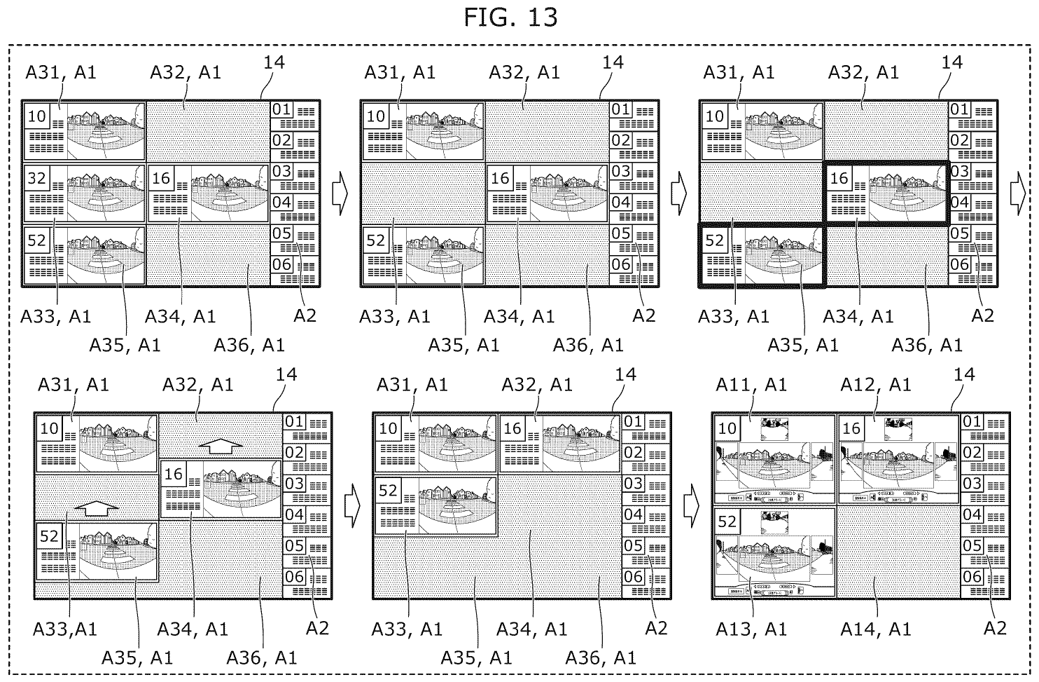

Hereinafter, a description will be given of a case where any one mobile body information item of a plurality of mobile body information items displayed on display device 14 is deleted, with reference to an FIG. 12 and FIG. 13. FIG. 12 is a flowchart illustrating the second operation example of information processing terminal 1 according to the embodiment. FIG. 13 is an explanatory diagram of a specific operation in the second operation example of information processing terminal 1 according to the embodiment.

As illustrated in FIG. 12, when an input to stop monitoring of any of mobile bodies 2 is given by the input to input device 15 by the operator, processor 13 stops obtaining of the mobile body information item of this mobile body 2, that is, the mobile body information item to be deleted (S401). Subsequently, obtainer 12 does not request the mobile body information item to be deleted, from remote control system 3. Then, processor 13 clears display area A1 of the mobile body information item to be deleted on display device 14 (S402). Subsequently, display area A1 in which the mobile body information item to be deleted has been displayed on display device 14 turns into empty display area A1 in which no mobile body information item is displayed.

Next, processor 13 checks whether or not empty display area A1 satisfies a predetermined condition (S403). Here, the predetermined condition means that a plurality of empty display areas A1 are present, and the total number of separations of display areas A1 on display device 14 can be decreased by moving one or more mobile body information items. When empty display area A1 does not satisfy the predetermined condition (S403: No), processor 13 maintains the current display of the plurality of mobile body information items on display device 14. On the other hand, when empty display area A1 satisfies the predetermined condition (S403: Yes), next, processor 13 compares the total number of columns and the total number of rows of display areas A1 on display device 14 (S404).

When the total number of rows of display areas A1 is greater than the total number of columns (S404: Yes), processor 13 sets the mobile body information item that is present in the same column as the column of empty display area A1 to an item to be moved (S405). Then, processor 13 displays the mobile body information item of the item to be moved on display device 14 in an emphasized manner (S406), and moves the mobile body information item of the item to be moved in a column direction (here, an upward direction) (S407). Thereafter, processor 13 deletes an empty row (S408). Accordingly, the total number of separations of display areas A1 on display device 14 is decreased.

On the other hand, when the total number of rows of display areas A1 is less than the total number of columns (S404: No), processor 13 sets the mobile body information item that is present in the same row as the row of empty display area A1 to an item to be moved (S409). Then, processor 13 displays the mobile body information item of the item to be moved on display device 14 in an emphasized manner (S410), and moves the mobile body information item of the item to be moved in a row direction (here, a left direction) (S411). Thereafter, processor 13 deletes an empty column (S412). Accordingly, the total number of separations of display areas A1 on display device 14 is decreased. It should be noted that when the total number of columns and the total number of rows on display device 14 are the same, processor 13 may execute any one of the processes in steps S405 to S408 and the processes in steps S409 to S412.

A specific example of the above-described process will be described with reference to FIG. 13. In the example illustrated in FIG. 13, the mobile body information item of mobile body 2 with the mobile body ID of “10” is displayed in first display area A31, and the mobile body information item of mobile body 2 with the mobile body ID of “32” is displayed in third display area A33. In addition, the mobile body information item of mobile body 2 with the mobile body ID of “16” is displayed in fourth display area A34, and the mobile body information item of mobile body 2 with the mobile body ID of “52” is displayed in fifth display area A35. Furthermore both second display area A32 and sixth display area A36 are empty display areas A1.

In the example illustrated in FIG. 13, a mobile body information item to be deleted is the mobile body information item of mobile body 2 with the mobile body ID of “32”. Therefore, third display area A33 is cleared, and empty display area A1 satisfies the predetermined condition. Consequently, processor 13 sets the mobile body information item of mobile body 2 with the mobile body ID of “16” and the mobile body information item of mobile body 2 with the mobile body ID of “52” to items to be moved, and displays these mobile body information items in an emphasized manner. Here, in each of fourth display area A34 and fifth display area A35 in which these mobile body information items of the items to be moved are displayed, processor 13 blinks the frame of display area A1, so as to display the mobile body information items of these items to be moved in an emphasized manner.

In addition, processor 13 moves these mobile body information items of the items to be moved in the upward direction. Here, processor 13 displays the change in the positions of these mobile body information items of the items to be moved by animation. Thereafter, since the row in which fifth display area A35 and sixth display area A36 are arranged becomes empty, processor 13 deletes this row. Consequently, the total number of separations of display areas A1 is decreased from “6” to “4”, and four display areas A1 (first display area A11, second display area A12, third display area A13, and fourth display area A14) are displayed on display device 14.

Here, the mobile body information item of mobile body 2 with the mobile body ID of “10” is displayed in first display area A11, the mobile body information item of mobile body 2 with the mobile body ID of “16” is displayed in second display area A12, and the mobile body information item of mobile body 2 with the mobile body ID of “52” is displayed in third display area A13. Therefore, there is no change in the relative position on display device 14 of each of the mobile body information items of mobile bodies 2 with the mobile body IDs of “10” and “52” displayed on display device 14 both before and after the decrease in the total number of separations of display areas A1. Specifically, there is no change in the positional relationship that the mobile body information item of mobile body 2 with the mobile body ID of “52” is located below the mobile body information item of mobile body 2 with the mobile body ID of “10”. That is, the relative positional relationship of these mobile body information items is retained.

It should be noted that, in the example illustrated in FIG. 13, the relative positional relationship between the mobile body information item of mobile body 2 with the mobile body ID of “10” and the mobile body information item of mobile body 2 with the mobile body ID of “16” is slightly disrupted. However, since the positional relationship that the mobile body information item of mobile body 2 with the mobile body ID of “16” is located generally to the right of the mobile body information item of mobile body 2 with the mobile body ID of “10” is maintained before and after the decrease of the total number of separations of display areas A1, the influence on the operator's recognition is relatively small.

### 2-5. Third Operation Example

Hereinafter, a third operation example that can be executed by information processing terminal 1 will be described. It should be noted that information processing terminal 1 may execute the basic operation example, and whether or not to execute the third operation example is optional. The third operation example is different from the second operation example in that processor 13 does not change the position of a mobile body information item that is set in advance. That is, in the third operation example, when the display of a plurality of mobile body information items on display device 14 is changed, processor 13 retains the position of the mobile body information item related to a specific mobile body 2 among one or more mobile body information items displayed on display device 14 both before and after the change. Here, specific mobile body 2 is, for example, mobile body 2 that is intensively monitored by the operator, and for which it is not desired that the position of the mobile body information item on display device 14 is changed.

In addition in the third operation example, processor 13 determines whether or not each mobile body 2 is specific mobile body 2 by referring to the state information of each mobile body 2. That is, in the third operation example, processor 13 determines specific mobile body 2 based on the plurality of state information items respectively indicating the states of the plurality of mobile bodies 2.

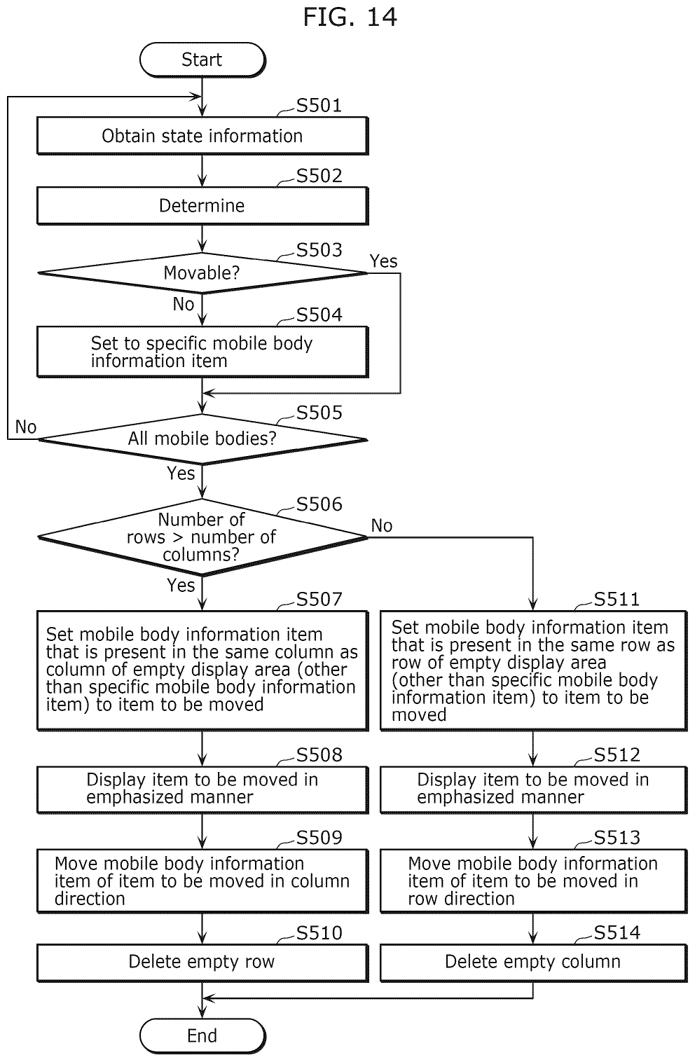

Hereinafter, a description will be given of a case where any one mobile body information item of the plurality of mobile body information items displayed on display device 14 is set to a specific mobile body information item, with reference to FIG. 14. FIG. 14 is a flowchart illustrating the third operation example of information processing terminal 1 according to the embodiment.

It should be noted that the flowchart illustrated in FIG. 14 represents a process to be executed when empty display area A1 satisfies the predetermined condition (S403: Yes) in the process in step S403 in the second operation example (refer to FIG. 12).

As illustrated in FIG. 14, processor 13 obtains the state information for any one of mobile bodies 2 (S501). Then, processor 13 determines whether or not the mobile body information item of this mobile body 2 is movable, based on the obtained state information (S502). When the mobile body information item of this mobile body 2 is not movable (S503: No), processor 13 sets the mobile body information item of this mobile body 2 to a specific mobile body information item (S504). On the other hand, when the mobile body information item of this mobile body 2 is movable (S503: Yes), processor 13 does not set the mobile body information item of this mobile body 2 to a specific mobile body information item.

When the processes in steps S501 to S504 have not been executed for all mobile bodies 2 (S505: No), processor 13 executes the processes in steps S501 to S504 for the other mobile bodies 2. On the other hand, when the processes in steps S501 to S504 have been executed for all mobile bodies 2 (S505: Yes), processor 13 executes the process in step S506 and the subsequent steps, which will be described later.

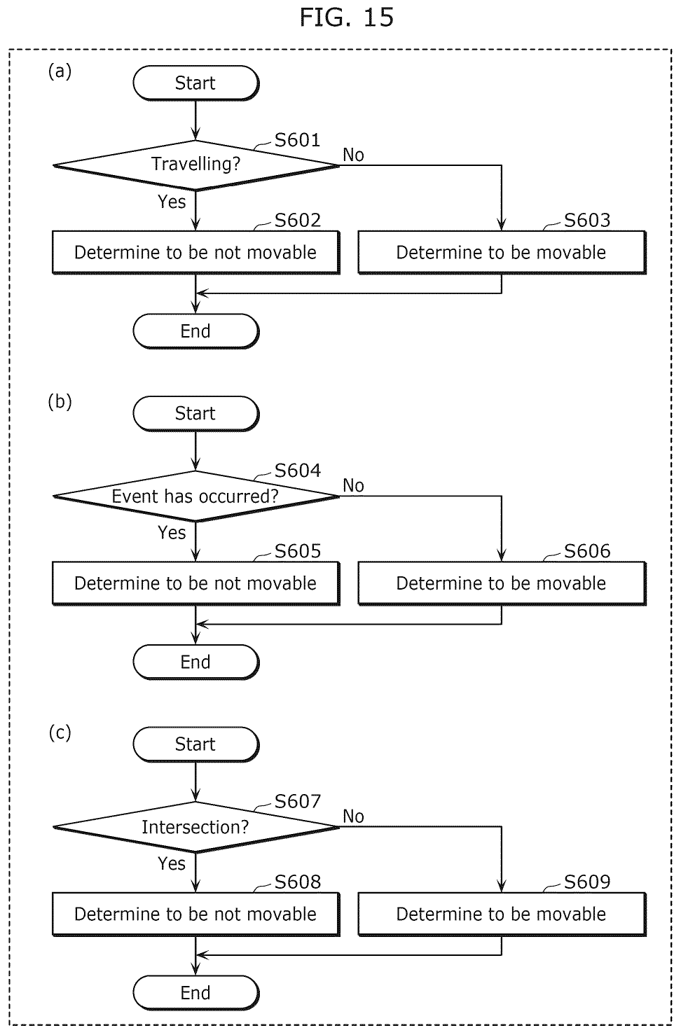

Here, a description will be given of the process of determining whether or not the mobile body information item of mobile body 2 is movable based on state information, with reference to FIG. 15. FIG. 15 is a flowchart illustrating an example of determination of a specific mobile body information item in the third operation example of information processing terminal 1 according to the embodiment.

(a) in FIG. 15 is an example of the process of determining whether or not a mobile body information item is movable, based on whether or not mobile body 2 is travelling. Specifically, processor 13 refers to the state information of mobile body 2, so as to check whether or not mobile body 2 is travelling (S601). When mobile body 2 is travelling (S601: Yes), processor 13 determines that the mobile body information item of mobile body 2 is not movable (S602). On the other hand, when mobile body 2 is not travelling (S602: No), processor 13 determines that the mobile body information item of mobile body 2 is movable (S603).

(b) in FIG. 15 is an example of the process of determining whether or not a mobile body information item is movable, based on whether or not an event has occurred in mobile body 2. Here, an event means a phenomenon that is to be particularly monitored by the operator, such as gaze alert generated by mobile body 2, or failure in mobile body 2. Specifically, processor 13 refers to the state information of mobile body 2, so as to check whether or not an event has occurred in mobile body 2 (S604). When an event has occurred in mobile body 2 (S604: Yes), processor 13 determines that the mobile body information item of this mobile body 2 is not movable (S605). On the other hand, when an event has not occurred in mobile body 2 (S604: No), processor 13 determines that the mobile body information item of this mobile body 2 is movable (S606).

(c) in FIG. 15 is an example of the process of determining whether or not a mobile body information item is movable, based on whether or not mobile body 2 is at an intersection. Specifically, processor 13 refers to the state information of mobile body 2, so as to check whether or not mobile body 2 is at an intersection (S607). When mobile body 2 is at an intersection (S607: Yes), processor 13 determines that the mobile body information item of this mobile body 2 is not movable (S608). On the other hand, when mobile body 2 is not at an intersection (S607: No), processor 13 determines that the mobile body information item of this mobile body 2 is movable (S609).

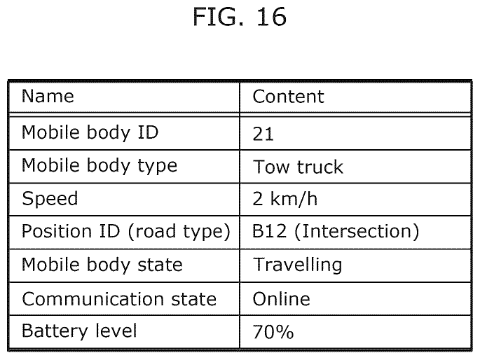

FIG. 16 is a diagram illustrating one example of the state information. In FIG. 16, “mobile body type” indicates the type of mobile body 2, “speed” indicates the speed of mobile body 2, and “position ID (road type)” indicates in what location mobile body 2 is located. In addition, in FIG. 16, “mobile body state” indicates the state of mobile bodies 2, such as whether or not mobile body 2 is travelling, or whether or not mobile body 2 is remotely operated, “communication state” indicates the communication state between mobile body 2 and remote control system 3, and “battery level” indicates the remaining power of a battery mounted on mobile body 2.

It should be noted that processor 13 may refer to a parameter other than the parameters illustrated in FIG. 15 included in the state information, so as to determine whether or not the mobile body information item of mobile body 2 is movable. For example, processor 13 may refer to the remaining power of the battery of mobile body 2, so as to determine whether or not the mobile body information item of mobile body 2 is movable. In this case, when the remaining power of the battery of mobile body 2 is equal to or less than a threshold value, processor 13 determines that the mobile body information item of this mobile body 2 is not movable, and when the remaining power of the battery of mobile body 2 exceeds the threshold value, processor 13 may determine that the mobile body information item of this mobile body 2 is movable.

Returning to FIG. 14, next, processor 13 compares the total number of columns and the total number of rows of display areas A1 on display device 14 (S506).

When the total number of rows of display areas A1 is more than the total number of columns (S506: Yes), processor 13 sets a mobile body information item that is present in the same column as the column of empty display area A1, and that is other than the specific mobile body information item to an item to be moved (S507). Then, processor 13 displays the mobile body information item of the item to be moved on display device 14 in an emphasized manner (S508), and moves the mobile body information item of the item to be moved in the column direction (here, the upward direction) (S509). Then, processor 13 deletes an empty row (S510). Accordingly, the total number of separations of display areas A1 on display device 14 is decreased.

On the other hand, when the total number of rows of display areas A1 is less than the total number of columns (S506: No), processor 13 sets a mobile body information item that is present in the same row as the row of empty display area A1, and that is other than the specific mobile body information item to an item to be moved (S511). Then, processor 13 displays the mobile body information item of the item to be moved on display device 14 in an emphasized manner (S512), and moves the mobile body information item of the item to be moved in the row direction (here, the left direction) (S513). Then, processor 13 deletes an empty column (S514). Accordingly, the total number of separations of display areas A1 on display device 14 is decreased. It should be noted that when the total number of columns and the total number of rows on display device 14 are the same, processor 13 may execute any one of the processes in steps S507 to S510 and the processes in steps S511 to S514.

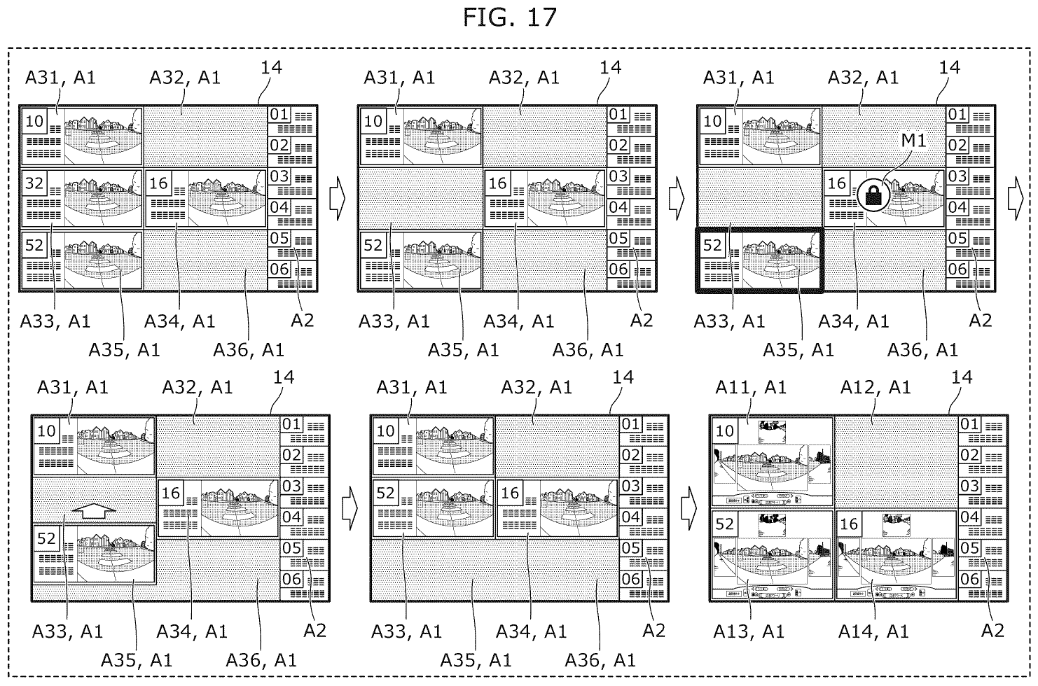

A specific example of the above-described process will be described with reference to FIG. 17. FIG. 17 is an explanatory diagram of a specific operation in the third operation example of information processing terminal 1 according to the embodiment. In the example illustrated in FIG. 17, the mobile body information item of mobile body 2 with the mobile body ID of “10” is displayed in first display area A31, and the mobile body information item of mobile body 2 with the mobile body ID of “32” is displayed in third display area A33. In addition, the mobile body information item of mobile body 2 with the mobile body ID of “16” is displayed in fourth display area A34, and the mobile body information item of mobile body 2 with the mobile body ID of “52” is displayed in fifth display area A35. Furthermore, both second display area A32 and sixth display area A36 are empty display areas A1.

In the example illustrated in FIG. 17, a mobile body information item to be deleted is the mobile body information item of mobile body 2 with the mobile body ID of “32”. Therefore, third display area A33 is cleared, and empty display area A1 satisfies the predetermined condition. Consequently, processor 13 sets the mobile body information item of mobile body 2 with the mobile body ID of “16” to a specific mobile body information item, and sets the mobile body information item of mobile body 2 with the mobile body ID of “52” to an item to be moved. Then, processor 13 displays the mobile body information item of mobile body 2 with the mobile body ID of “52” in an emphasized manner. Here, in fifth display area A35 in which the mobile body information item of the item to be moved is displayed, processor 13 blinks the frame of display area A1, so as to display the mobile body information item of the item to be moved in an emphasized manner. In addition, processor 13 displays mark M1 on the mobile body information item of mobile body 2 with the mobile body ID of “16”. Accordingly, the operator can identify that the mobile body information item of this mobile body 2 is the specific mobile body information item, and its position is not changed.

Then, processor 13 moves the mobile body information item of the item to be moved in the upward direction. Here, processor 13 displays the change in the position of the mobile body information item of the item to be moved by animation. Thereafter, since the row in which fifth display area A35 and sixth display area A36 are arranged becomes empty, processor 13 deletes this row. Consequently, the total number of separations of display areas A1 is decreased from “6” to “4”, and four display areas A1 (first display area A11, second display area A12, third display area A13, and fourth display area A14) are displayed on display device 14.

Here, the mobile body information item of mobile body 2 with the mobile body ID of “10” is displayed in first display area A11, the mobile body information item of mobile body 2 with the mobile body ID of “52” is displayed in third display area A13, and the mobile body information item of mobile body 2 with the mobile body ID of “16” is displayed in fourth display area A14. Therefore, there is no change in the relative position on display device 14 of each of the mobile body information items of mobile bodies 2 with the mobile body IDs of “10”, “16”, and “52” displayed on display device 14 both before and after the decrease in the total number of separations of display areas A1. Specifically, there is no change in the positional relationship that the mobile body information items of mobile bodies 2 with the mobile body IDs of “52” and “16” are respectively located below, and diagonally below and to the right of the mobile body information item of mobile body 2 with the mobile body ID of “10”. That is, the relative positional relationship of these mobile body information items is retained.

It should be noted that, in the third operation example, processor 13 may set any of the mobile body information items to a specific mobile body information item, according to an input to input device 15 by the operator. In this case, processor 13 need not execute the processes in steps S501 to S505 (refer to FIG. 14).

### 2-6. Fourth Operation Example

Hereinafter, a fourth operation example that can be executed by information processing terminal 1 will be described. It should be noted that information processing terminal 1 may execute the basic operation example, and whether or not to execute the fourth operation example is optional. The fourth operation example is different from the basic operation example in that deletion and addition of a mobile body information item is collectively performed.

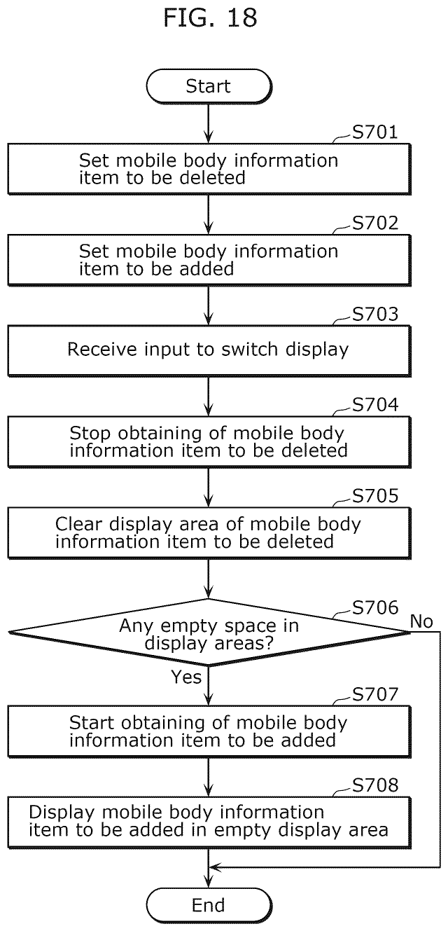

FIG. 18 is a flowchart illustrating the fourth operation example of information processing terminal 1 according to the embodiment. First, when an input to stop monitoring of any of mobile bodies 2 is given by the input to input device 15 by the operator, processor 13 sets the mobile body information item of this mobile body 2 to the mobile body information item to be deleted (S701). In addition, when an input to start monitoring of any of mobile bodies 2 is given by the input to input device 15 by the operator, processor 13 sets the mobile body information item of this mobile body 2 to the mobile body information item to be added (S702). It should be noted that steps S701 and S702 may be executed in the reverse order.

Thereafter, when an input to switch the display on display device 14 is given by the input to input device 15 by the operator, processor 13 receives the input to switch the display (S703). Then, processor 13 stops obtaining of the mobile body information item to be deleted (S704). Subsequently, obtainer 12 does not request the mobile body information item to be deleted, from remote control system 3. Then, processor 13 clears display area A1 of the mobile body information item to be deleted on display device 14 (S705). Subsequently, display area A1 in which the mobile body information item to be deleted has been displayed on display device 14 turns into empty display area A1 in which no mobile body information items is displayed.

Next, processor 13 checks whether or not there is an empty space in display areas A1 on display device 14 (S706). When there is an empty space in display areas A1 on display device 14, that is, when empty display area A1 is present (S706: Yes), processor 13 starts obtaining of the mobile body information item to be added (S707). Subsequently, obtainer 12 requests the mobile body information item to be added, from remote control system 3. Then, processor 13 displays the mobile body information item to be added in empty display area A1 on display device 14 (S708). On the other hand, when there is no empty space in display areas A1 on display device 14 (S706: No), processor 13 maintains the current display of the plurality of mobile body information items on display device 14.

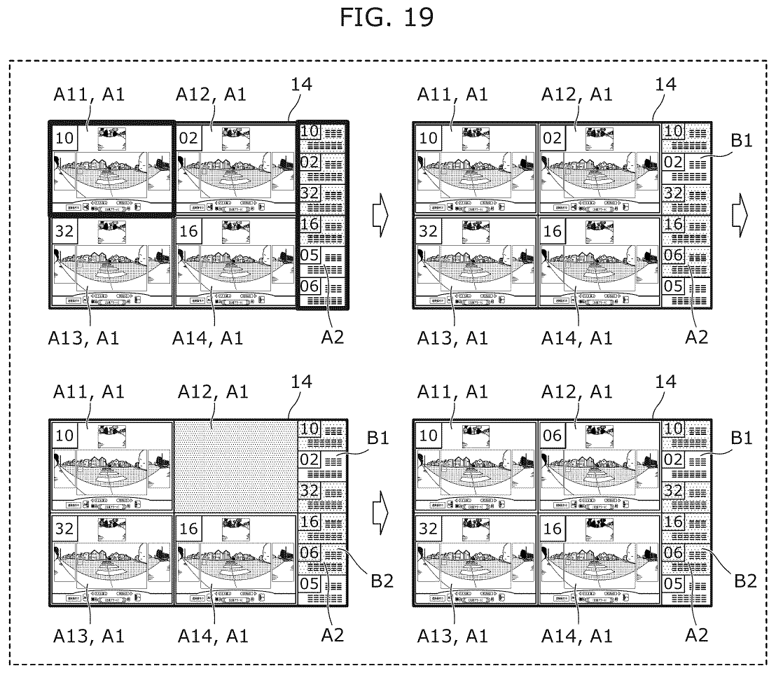

A specific example of the above-described process will be described with reference to FIG. 19. FIG. 19 is an explanatory diagram of a specific operation in the fourth operation example of information processing terminal 1 according to the embodiment. In the example illustrated in FIG. 19, four display areas A1 (first display area A11, second display area A12, third display area A13, and fourth display area A14) and list A2 are displayed on display device 14. The mobile body information item of mobile body 2 with the mobile body ID of “10” is displayed in first display area A11, and the mobile body information item of mobile body 2 with the mobile body ID of “02” is displayed in second display area A12. In addition, the mobile body information item of mobile body 2 with the mobile body ID of “32” is displayed in third display area A13, and the mobile body information item of mobile body 2 with the mobile body ID of “16” is displayed in fourth display area A14.

In addition, in list A2, a plurality of mobile bodies 2 that are specified by the operator, that is, that are monitored by the operator, are brightly displayed. Furthermore, in list A2, the other mobile bodies 2 that are not specified by the operator, that is, that are not monitored by the operator, are darkly displayed. In the example illustrated in FIG. 19, since mobile bodies 2 with the mobile body IDs of “10”, “02”, “32”, and “16” are specified, these mobile bodies 2 are brightly displayed in list A2.

In the example illustrated in FIG. 19, the operator gives an input to stop monitoring of mobile body 2 with the mobile body ID of “02”, and gives an input to start monitoring of mobile body 2 with the mobile body ID of “06”. Then, in the example illustrated in FIG. 19, after giving these inputs, the operator gives an input to switch the display. Consequently, second display area A12 in which the mobile body information item of mobile body 2 with the mobile body ID of “02”, which is the mobile body information item to be deleted, is displayed is cleared, and second display area A12 becomes empty display area A1. Next is the mobile body information item to be added. The mobile body information item of mobile body 2 with the mobile body ID of “06” is displayed in second display area A12, which is empty display area A1.

In addition, in the example illustrated in FIG. 19, there is no change in the position on display device 14 of each of the mobile body information items of mobile bodies 2 with the mobile body IDs of “10”, “32”, and “16” displayed on display device 14 both before and after the deletion and addition of the mobile body information items (that is, before and after the change). That is, the relative positional relationship of these mobile body information items is retained.

### OTHER EMBODIMENTS

Although the information processing method and information processing terminal 1 according to one or more aspects of the present disclosure have been described based on an embodiment, the present disclosure is not limited to the embodiment. Forms obtained by various modifications to any of the embodiments which may be conceived by those skilled in the art or forms achieved by arbitrarily combining elements from different embodiments may be also included in a range of one or more aspects of the present disclosure so long as they do not depart from the essence of the present disclosure.

For example, in the embodiment, mobile body 2 is configured so that it can be remotely operated by the operator, but is not limited to this, and mobile body 2 may be configured so that it cannot be remotely operated by the operator. In this case, mobile body 2 need not include remote operation controller 25. In addition, for example, in the embodiment, mobile body 2 may be able to at least move autonomously, and may include a security robot, an elevator, a work robot, or the like, in addition to an automatic delivery robot. Of course, a security robot, an elevator, a work robot, or the like may be configured so that it can be remotely operated by the operator.

For example, in the second operation example of the embodiment, processor 13 may display the movement of a mobile body information item whose position is changed by animation, without executing the display retaining process. That is, the information processing method is to be executed by a computer, and includes: obtaining a plurality of mobile body information items respectively related to a plurality of mobile bodies 2; and causing display device 14 to display the plurality of mobile body information items obtained, and when a change in the number of display areas A1 changes the position of a mobile body information item among the mobile body information items on display device 14, display device 14 may be caused to display the change in the position of the mobile body information item by animation.

For example, in the second operation example of the embodiment, processor 13 may display the mobile body information item whose position is changed in an emphasized manner, without executing the display retaining process. That is, the information processing method is to be executed by a computer, and includes: obtaining a plurality of mobile body information items respectively related to a plurality of mobile bodies 2; and causing display device 14 to display the plurality of mobile body information items obtained, and when a change in the display of the plurality of mobile body information items on display device 14 changes the position of a mobile body information item among the mobile body information items on display device 14, display device 14 may be caused to display the mobile body information item more emphasized than the remainder of the mobile body information items.

For example, the present disclosure can be implemented as a program for causing a processor to execute steps included in the information processing method. Moreover, the present disclosure can be implemented as a non-transitory computer-readable recording medium such as a CD-ROM on which the program is recorded.

When the present disclosure is implemented by a program (software), for example, each of the steps is executed by the program executed by utilizing hardware resources of, for instance, a CPU, memory, and an input/output circuit in the computer. In other words, each step is executed by the CPU obtaining or calculating data from, for instance, the memory or the input/output circuit, or outputting a calculation result to the memory or the input/output circuit.

It should be noted that in the foregoing embodiment, each element included in information processing terminal 1 may be configured by dedicated hardware or may be implemented by executing a software program suitable for the constituent element. Each constituent element may be implemented by a program executor such as a CPU or a processor reading out and executing a software program recorded onto a recording medium such as a hard disk or semiconductor memory.

Some or all of the functions of information processing terminal 1 according to the embodiment may be implemented as a large scale integration circuit that is typically an integrated circuit. These functions need not be implemented as LSIs but may be implemented as dedicated circuits or general-purpose processors. A field programmable gate array (FPGA) that can be programmed or a reconfigurable processor that can reconfigure the connection or configuration of circuit cells in the LSI may be used.

Various modifications to which changes within a range that may be conceived by those skilled in the art are made to any of the embodiments of the present disclosure are also included in the present disclosure so long as they do not depart from the essence of the present disclosure.

### INDUSTRIAL APPLICABILITY

The present disclosure can be applied to systems that manage mobile bodies that move autonomously.

1. An information processing method to be executed by a computer, the information processing method comprising:
obtaining mobile body information items respectively related to mobile bodies;
causing a display device to display the mobile body information items obtained; and
retaining, when the display of the mobile body information items on the display device is changed, a relative positional relationship of one or more mobile body information items displayed on the display device both before and after the change.

2. The information processing method according to claim 1, wherein
the mobile body information items are separately displayed in display areas of the display device, and
when a total number of the display areas is changed, the relative positional relationship of the one or more mobile body information items displayed on the display device both before and after the change is retained.

3. The information processing method according to claim 2, wherein
when a change in the total number of the display areas changes a position of a mobile body information item among the mobile body information items on the display device, the display device is caused to display the change in the position of the mobile body information item by animation.

4. The information processing method according to claim 1, wherein
when a change in the display of the mobile body information items on the display device changes a position of a mobile body information item among the mobile body information items on the display device, the display device is caused to display the mobile body information item more emphasized than a remainder of the mobile body information items.

5. The information processing method according to claim 1, wherein
when the display of the mobile body information items on the display device is changed, a position of a mobile body information item related to a specific mobile body among one or more mobile body information items displayed on the display device both before and after the change is retained.

6. The information processing method according to claim 5, wherein
the specific mobile body is determined based on state information items indicating states of the mobile bodies.

7. A non-transitory computer-readable recording medium for use in a computer, the recording medium having recorded thereon a computer program for causing the computer to execute the information processing method according to claim 1.

8. An information processing terminal comprising:
an obtainer that obtains mobile body information items respectively related to mobile bodies; and
a processor that causes a display device to display the mobile body information items obtained by the obtainer, wherein
when the display of the mobile body information items on the display device is changed, the processor retains a relative positional relationship of one or more mobile body information items displayed on the display device both before and after the change.
